(19) United States
(12) Patent Application Publication
(10) Pub. No.: US 2008/0150389 A1
(43) Pub. Date: Jun. 26, 2008

(54) Electrical Machine With Slots

(75) Inventor: Christian Grabner, Erlangen (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 11/815,627

(22) PCT Filed: Jan. 24, 2006
(86) PCT No.: PCT/EP2006/050386

§ 371 Date: Aug. 6, 2007

(30) Foreign Application Priority Data
Feb. 7, 2005 (DE) 10 2005 005 602.4

(51) Int. Cl. H02K 1/16

(52) U.S. Cl. 310/216

(57) ABSTRACT

The aim of the invention is to minimize the local surface loss densities of the ferromagnetic material of an electric machine. An electric machine with a stator (2) that is made of layered sheet metal plates (1) is thus disclosed. The sheet metal plates (1) have slots (3) that are oriented in such a manner that a winding system (12) can be put into place, wherein each slot (3) has vertical symmetrical axes of varying lengths and a substantially round shape.

The invention relates to an electrical machine having a stator formed from layers of laminates, with the laminates having slots which are aligned such that a winding system can be accommodated.

In the case of conventional slots, in particular in synchronous machines with permanent-magnet excitation, for example as described in the specialist article Analysis of Flux Distribution and Core Losses”, local magnetic saturation phenomena occur on sharp edges along a contour of the laminate section of the stator in a polyphase machine. This slot shape of the previous polyphase machines represents a train of polygons, which essentially has a rectangular or trapezoidal base area. This results in additional iron losses.

Against this background, the object of the invention is to avoid the iron losses resulting from local magnetic saturation phenomena in an electrical polyphase machine, in particular a synchronous machine with permanent magnet excitation.

The stated object is achieved in that each slot has an essentially round shape and has axes of symmetry which are at right angles to one another, are of different lengths and are referred to as the longitudinal axis and the lateral axis.

This results in the magnetic field being homogenized, and in an associated reduction in the losses.

In one embodiment, the slots are shaped elliptically. This eliminates the negative effects of magnetic pronounced saturation of the material in the edges. On the other hand, in the case in particular of those electrical machines which have toothed-coil windings, comparatively small numbers of slots in the stator and pronounced pole shoe values, the entire profile of the magnetic field over wide areas of the air gap and the insulation, whose magnetic effect is approximately the same as that of air, as well as the copper areas is distributed better, since the negative influences of the sharp edges in the magnetic circuit are avoided.

This admittedly results in the slot having a cross-sectional area which is reduced by the factor π in comparison to a rectangle, but this has no disturbing effect, for example when using toothed-coil technology, since sufficient space is available in any case with a comparatively small number of slots, for example six, nine or twelve in the stator, and with the electrical machine having a correspondingly large diameter. When using toothed-coil technology the positive influence of the homogenizing of the magnetic field resulting from the elliptical edge shapes in area of the individual slots predominates to a greater extent than in the case of types with a comparatively large number of stator slots.

The undesirable flux density amplitudes in particular in the tooth heads, that is to say in the area of the air gap, are avoided, thus reducing the local surface loss densities there.

The invention and further advantageous refinements of the invention as claimed in the dependent claims will be explained in more detail with reference to schematically illustrated exemplary embodiments, in which:

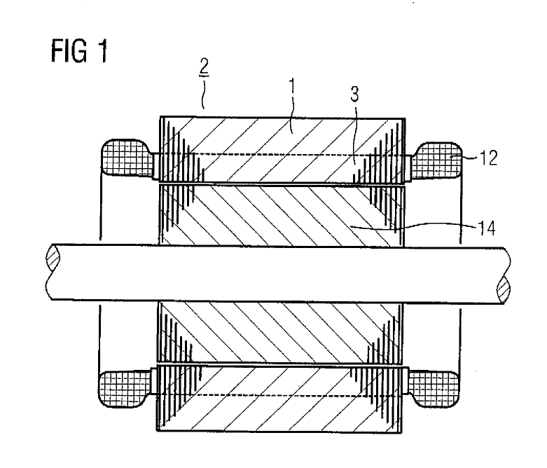

FIG. 1 shows an outline illustration of an electrical machine,

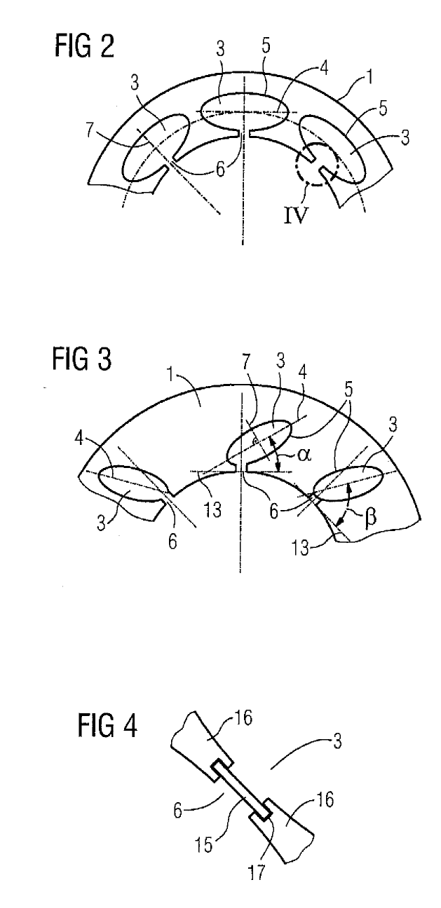

FIG. 2 shows a laminate section of a laminate,

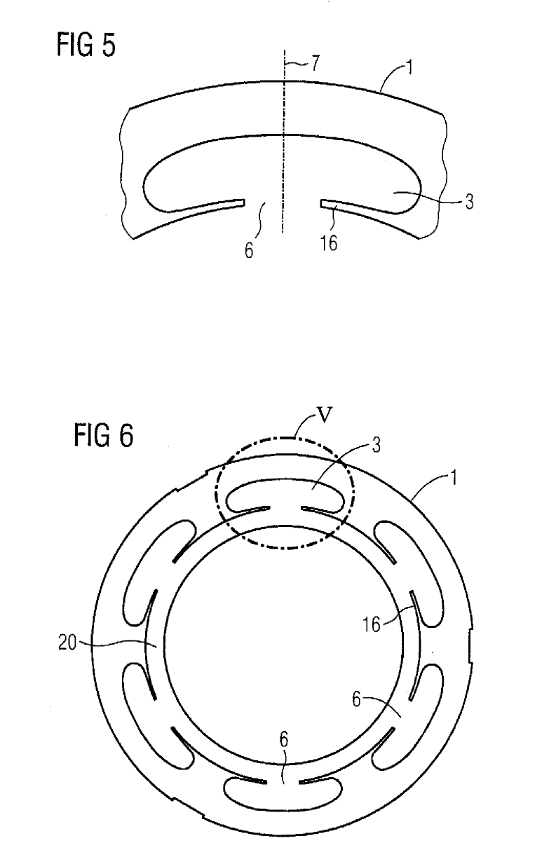

FIGS. 3 and 5 show a further laminate section

FIG. 4 shows a detailed illustration of a slot mouth, and

FIG. 6 shows a laminate section with six slots.

FIG. 1 shows the fundamental design of an electrical machine, which is not illustrated in any more detail, with a stator 2 formed from layers of laminates 1. The schematically illustrated rotor is 14 is provided with permanent magnets, which are either arranged in axially running recesses in the laminated core of the rotor 14 or are positioned in the surface of rows 14, and are secured by a binding.

The laminates 1 in the stator 2 as shown in FIG. 2 have slots 3 which have an elliptical shape and run essentially axially. In this case, the longitudinal axis 4 of the ellipse 5 is aligned parallel to an imaginary tangent 13 to the air gap which corresponds with this slot 3. The lateral axis 7 of the ellipse 5 is aligned at right angles to this imaginary tangent 13. The longitudinal axis 4 and the lateral axis 7 form the axes of symmetry of the ellipse 5.

FIG. 3 shows a plurality of different arrangements of the slots 3, which are in the form of an ellipse 5. These different angles α, β of the longitudinal axis 4 of the ellipses 5 with respect to the associated tangents 13 at the air gap may be provided in a laminate 1 and in a laminated core. The longitudinal axis 4 is in each case aligned at a predetermined angle α or β to an imaginary tangent 13 of this slot on the tangent 13 of the air gap.

A laminate 1 or a laminated core may, however, also have slots 3 at only one predetermined angle, α or β.

The slot mouths 6 of the elliptical slots 3 are advantageously inclined at an angle over the axial length of the stator 2. This is intended to reduce the cogging torques. This inclination angle is advantageously between half of the slot pitch and two slot pitches.

Irrespective of the embodiments, local surface loss densities in the ferromagnetic material of the laminate 1 are therefore reduced during operation of the electrical machine.

The winding systems 12 provided in the slots 3 are fractional-pitch windings or toothed coils. Once the winding systems 12 have been inserted, for example by means of needle winders that are known per se, into the slots 3, the windings are encapsulated and, if appropriate, the slot mouths 6 between two tooth heads 16 as shown in FIG. 4 are filled and closed by means of suitable materials. These slot closure elements 15 are a magnetic or magnetic and are advantageously positioned in axially running recesses 17 in the tooth heads 16.

In a further embodiment shown in FIG. 5, the slots 3 are not strictly elliptical but, particularly when the numbers of slots are small, for example six, are in each case matched to the profile of the air gap at the end of their longitudinal axis 4.

The electrical machine according to the invention has four poles (2p=4), and has six slots 3 in the stator 2 with a three-phase feed, as shown in FIG. 6.

1.-8. (canceled)

9. An electrical machine, comprising:
a stator formed from layers of laminates, each said laminate having slots, each said slot being configured to define a longitudinal axis and a transverse axis which extend at a right angle to one another and have different lengths; and
a winding system accommodated in the slots,
wherein each said slot is shaped elliptically, with the longitudinal axis of the slot arranged at a predetermined angle to an associated tangent.

10. The electrical machine of claim 9, wherein the laminate has slots with different angles.

11. The electrical machine of claim 9, wherein the longitudinal axis of the slot is arranged radially with respect to a machine axis of the electrical machine.

12. The electrical machine of claim 9, wherein the longitudinal axis of the slot is arranged tangentially with respect to a machine axis of the electrical machine.

13. The electrical machine of claim 9, wherein the stator has four poles.

14. The electrical machine of claim 9, wherein the stator has six poles.

15. The electrical machine of claim 9, wherein the stator has eight poles.

16. The electrical machine of claim 9, wherein the winding system is formed from toothed coils.

17. The electrical machine of claim 9, wherein the winding system is formed from fractional-pitch coils.

18. The electrical machine of claim 9, wherein the stator has a slot mouth filling.

19. The electrical machine of claim 9, wherein the slot has a slot mouth adjacent an air gap, said laminate having an inner circumferential boundary line, with the tangent extending tangent to the boundary line in an area of the slot mouth.

20. The electrical machine of claim 9, wherein the slot has a slot mouth adjacent an air gap, said slot mouth being inclined at an angle in relation to a length axis of the stator.

21. The electrical machine of claim 20, wherein the inclination angle is between half of a slot pitch and two slot pitches.
